(19) United States
(12) Patent Application Publication
(10) Pub. No.: US 2018/0346641 A1
(43) Pub. Date: Dec. 6, 2018

(54) LIQUID CRYSTAL POLYESTER COMPOSITION, MOLDED BODY, AND CONNECTOR

(71) Applicant: Sumitomo Chemical Company, Limited, Tokyo (JP)

(72) Inventor: Hiromitsu HEGI, Tsukuba-shi (JP)

(21) Appl. No.: 15/761,584

(22) PCT Filed: Sep. 23, 2016
(86) PCT No.: PCT/JP2016/078044

§ 371 Date: Mar. 20, 2018

(30) Foreign Application Priority Data
Sep. 25, 2015 (JP) 2015-187547

(51) Int. Cl. C08G 63/60; C08K 3/34; C08K 7/00; H01R 13/50; H01R 43/18

(52) U.S. Cl. CPC C08G 63/605; C08K 3/34; C08K 7/00; C08K 2201/005; H01R 43/18; C08K 2003/343; H01R 13/50

(57) ABSTRACT

A liquid crystal polyester composition which includes liquid crystal polyester and a plate-like inorganic filler is provided. In a case where 10 grams of the plate-like inorganic filler is mixed with 90 mL of ion exchange water having a pH of 7.0 to prepare an aqueous dispersion, the pH of a solution portion of the aqueous dispersion is 7.0 to 9.0. A particle diameter D90 of the plate-like inorganic filler is 20 to 140 μm. A molded body and connector can be obtained by molding the liquid crystal polyester composition. The liquid crystal polyester composition provides a molded body on which a blister is hardly generated under high temperature conditions.

### TECHNICAL FIELD

The present invention relates to a liquid crystal polyester composition, and a molded body and a connector obtained by molding the same.

Priority is claimed on Japanese Patent Application No. 2015-187547, filed on Sep. 25, 2015, the content of which is incorporated herein by reference.

### BACKGROUND ART

Since liquid crystal polyester has excellent melt fluidity and high heat resistance or strength and rigidity, the liquid crystal polyester is suitably used as an injection molding material for manufacturing electrical and electronic equipment and is suitable for manufacturing a connector and the like, for example. However, a molecular chain of the liquid crystal polyester is easily oriented in a flow direction at the time of the molding, and thus, anisotropy of a coefficient of contraction and a coefficient of expansion or mechanical properties may easily occur. In order to solve such problems, studies have been carried out regarding injection molding performed by using a liquid crystal polyester composition obtained by mixing mica into liquid crystal polyester.

### CITATION LIST

### Patent Literature

[Patent Document 1] Japanese Unexamined Patent Application, First Publication No. H3-167252

### SUMMARY OF INVENTION

### Technical Problem

However, although a liquid crystal polyester composition of the related art including the liquid crystal polyester described above and a plate-like inorganic filler such as mica has provided a molded body in which occurrence of anisotropy was prevented, in a case where a molded body is exposed to a high temperature during soldering or the like, a so-called blister which is swell of a surface is easily generated.

The invention is made in consideration of these circumstances and an object thereof is to provide a liquid crystal polyester composition which includes liquid crystal polyester and a plate-like inorganic filler and provides a molded body on which a blister is hardly generated under high temperature conditions, and a molded body obtained by molding the liquid crystal polyester composition.

### Solution to Problem

In order to solve the aforementioned problems, the following configurations are used in the present invention.

[1] A liquid crystal polyester composition including: liquid crystal polyester; and a plate-like inorganic filler, in which, in a case where 10 g of the plate-like inorganic filler is mixed with 90 mL of ion exchange water having pH of 7.0 to prepare an aqueous dispersion, the pH of a solution portion of the aqueous dispersion is 7.0 to 9.0, and a particle diameter D90 of the plate-like inorganic filler is 20 to 140 μm.

[2] The liquid crystal polyester composition according to [1], in which the amount of the plate-like inorganic filler is 10 to 250 parts by mass with respect to 100 parts by mass of the amount of the liquid crystal polyester.

[3] The liquid crystal polyester composition according to [1] or [2], in which the plate-like inorganic filler is mica.

[4] The liquid crystal polyester composition according to any one of [1] to [3], in which the particle diameter D90 of the plate-like inorganic filler is 30 to 80 μm.

[5] The liquid crystal polyester composition according to any one of [1] to [4], in which the liquid crystal polyester includes a repeating unit represented by General Formula (1), a repeating unit represented by General Formula (2), and a repeating unit represented by General Formula (3).

—O—Ar¹—CO— (1)

—CO—Ar²—CO— (2)

—X—Ar³—Y— (3)

[in Formulae (1) to (3), Ar¹ represents one selected from the group consisting of a phenylene group, a naphthylene group, and a biphenylylene group, Ar² and Ar³ each independently represent one selected from the group consisting of a phenylene group, a naphthylene group, a biphenylylene group, and a group represented by General Formula (4), X and Y each independently represent an oxygen atom or an imino group, one or more hydrogen atoms in the group represented by Ar¹, Ar², or Ar³ may each be independently substituted with one selected from the group consisting of a halogen atom, an alkyl group having 1 to 28 carbon atoms, and an aryl group having 6 to 12 carbon atoms]

—Ar⁴—Z—Ar⁵— (4)

[in Formula (4), Ar⁴ and Ar⁵ each independently represent a phenylene group or a naphthylene group, and Z represents one selected from the group consisting of an oxygen atom, a sulfur atom, a carbonyl group, a sulfonyl group, and an alkylidene group having 1 to 28 carbon atoms.]

[6] A molded body obtained by molding the liquid crystal polyester composition according to any one of [1] to [5].

[7] A connector obtained by molding the liquid crystal polyester composition according to any one of [1] to [5].

[8] A manufacturing method of a molded body including: molding the liquid crystal polyester composition according to any one of [1] to [6] to obtain a molded body of liquid crystal polyester.

[9] A manufacturing method of a connector including: molding the liquid crystal polyester composition according to any one of [1] to [6] to obtain a connector.

### Advantageous Effects of Invention

According to the present invention, a liquid crystal polyester composition which includes liquid crystal polyester and a plate-like inorganic filler and provides a molded body on which a blister is hardly generated under high temperature conditions, a molded body obtained by molding the liquid crystal polyester composition, and a connector obtained by molding the liquid crystal polyester composition.

### BRIEF DESCRIPTION OF DRAWINGS

FIG. 1 is a perspective view schematically showing a connector of an embodiment of the invention.

FIG. 2 is an enlarged front view showing main parts of the connector shown in FIG. 1.

### DESCRIPTION OF EMBODIMENTS

Hereinafter, suitable embodiments of the invention will be described.

<Liquid Crystal Polyester Composition>

A liquid crystal polyester composition of the embodiment is a liquid crystal polyester composition which includes liquid crystal polyester, and a plate-like inorganic filler, in which, in a case where 10 g of the plate-like inorganic filler is mixed with 90 mL of ion exchange water having a pH of 7.0 to prepare an aqueous dispersion, the pH of a solution portion of the aqueous dispersion is 7.0 to 9.0, and a particle diameter D90 of the plate-like inorganic filler is 20 to 140 μm.

By using a plate-like inorganic filler having the pH properties and the particle diameter D90 described above as the plate-like inorganic filler, the liquid crystal polyester composition of the embodiment can provide a molded body on which a blister is hardly generated under high temperature conditions (hereinafter, may be referred to as “high blister resistance). The embodiment is made in view of fact that the ease of generation of a blister on a molded body obtained by using the plate-like inorganic filler under high temperature conditions fluctuates even in a case where a plate-like inorganic filler having similar size and composition is used, and the reason of this fluctuation is due to a variation in acidity and the particle diameter D90 of the plate-like inorganic filler.

[Liquid Crystal Polyester]

The liquid crystal polyester is liquid crystal polyester showing liquid crystalline properties in a melted state. The liquid crystal polyester preferably melts at a temperature equal to or lower than 450° C. The liquid crystal polyester may be liquid crystal polyester amide, may be liquid crystal polyester ether, may be liquid crystal polyester carbonate, or may be liquid crystal polyester imide. The liquid crystal polyester is preferably wholly aromatic liquid crystal polyester obtained by using only aromatic compounds as a raw material monomer.

Typical examples of the liquid crystal polyester include a material obtained by condensation polymerization of aromatic hydroxycarboxylic acid, aromatic dicarboxylic acid, and at least one compound selected from the group consisting of aromatic diol, aromatic hydroxylamine, and aromatic diamine, a material obtained by polymerization of plural kinds of aromatic hydroxycarboxylic acid, a material obtained by polymerization of aromatic dicarboxylic acid and at least one compound selected from the group consisting of aromatic diol, aromatic hydroxyamine, and aromatic diamine, and a material obtained by polymerization of polyester such as polyethylene terephthalate and aromatic hydroxycarboxylic acid. Here, regarding aromatic hydroxycarboxylic acid, aromatic dicarboxylic acid, aromatic diol, aromatic hydroxyamine, and aromatic diamine, polymerizable derivatives thereof may each be independently used instead of a part or the entire part thereof.

Examples of a polymerizable derivative of a compound including a carboxyl group such as aromatic hydroxycarboxylic acid and aromatic dicarboxylic acid include a material obtained by converting a carboxyl group into an alkoxycarbonyl group or an aryloxycarbonyl group (ester), a material obtained by converting a carboxyl group into a haloformyl group (acid halide), and a material obtained by converting a carboxyl group into a an acyloxycarbonyl group (acid anhydride). As an example of a polymerizable derivative of a compound including a hydroxyl group such as aromatic hydroxycarboxylic acid, aromatic diol, or aromatic hydroxyamine, a material obtained by acylating a hydroxyl group to convert it into an acyloxy group (acylated product) is used. As an example of a polymerizable derivative of a compound including an amino group such as aromatic hydroxylamine and aromatic diamine, a material obtained by acylating an amino group to convert it into an acylamino group (acylated product) is used.

The liquid crystal polyester preferably includes a repeating unit represented by General Formula (1) (hereinafter, may be referred to as a “repeating unit (1)”), and more preferably includes the repeating unit (1), a repeating unit represented by General

Formula (2) (hereinafter, may be referred to as a “repeating unit (2)”), and a repeating unit represented by General Formula (3) (hereinafter, may be referred to as a “repeating unit (3)”).

—O—Ar¹—CO— (1)

—CO—Ar²—CO— (2)

—X—Ar³—Y— (3)

[In Formulae (1) to (3), Ar¹ represents one selected from the group consisting of a phenylene group, a naphthylene group, and a biphenylylene group. Ar² and Ar³ each independently represent one selected from the group consisting of a phenylene group, a naphthylene group, a biphenylylene group, and a group represented by General Formula (4). X and Y each independently represent an oxygen atom or an imino group (—NH—). One or more hydrogen atoms in the group represented by Ar¹, Ar², or Ar³ may each be independently substituted with one selected from the group consisting of a halogen atom, an alkyl group having 1 to 28 carbon atoms, and an aryl group having 6 to 12 carbon atoms.]

—Ar⁴—Z—Ar⁵— (4)

[In Formula (4), Ar⁴ and Ar⁵ each independently represent a phenylene group or a naphthylene group. Z represents one selected from the group consisting of an oxygen atom, a sulfur atom, a carbonyl group, a sulfonyl group, and an alkylidene group having 1 to 28 carbon atoms.]

Examples of the halogen atom which can be substituted with a hydrogen atom include a fluorine atom, a chlorine atom, a bromine atom and an iodine atom.

Examples of the alkyl group having 1 to 28 carbon atoms which can be substituted with a hydrogen atom include a methyl group, an ethyl group, an n-propyl group, an isopropyl group, an n-butyl group, an isobutyl group, a sec-butyl group, a tert-butyl group, an n-hexyl group, a 2-ethylhexyl group, an n-octyl group, and an n-decyl group. The number of carbon atoms in the alkyl group is preferably 1 to 10.

Examples of the aryl group having 6 to 12 carbon atoms which can be substituted with a hydrogen atom include a monocyclic aromatic group such as a phenyl group, an o-tolyl group, an m-tolyl group, or a p-tolyl group, and a condensed aromatic group such as a 1-naphthyl group or a 2-naphthyl group.

In a case where one or more hydrogen atoms in the group represented by Ar¹, Ar², or Ar³ are substituted with these groups, the number of substitution is preferably 1 or 2 for each group represented by Ar¹, Ar², or Ar³, each independently, and more preferably 1.

Examples of the alkylidene group having 1 to 28 carbon atoms include a methylene group, an ethylidene group, an isopropylidene group, an n-butylidene group, or a 2-ethylhexylidene group. The number of carbon atoms in the alkylidene group is preferably 1 to 10.

The repeating unit (1) is a repeating unit derived from predetermined aromatic hydroxycarboxylic acid.

As the repeating unit (1), a repeating unit in which Ar¹ is a 1,4-phenylene group (repeating unit derived from p-hydroxybenzoic acid), or a repeating unit in which Ar¹ is a 2,6-naphthylene group (repeating unit derived from 6-hydroxy-2-naphthoic acid) is preferable.

The repeating unit (2) is a repeating unit derived from predetermined aromatic dicarboxylic acid.

As the repeating unit (2), a repeating unit in which Ar² is a 1,4-phenylene group (repeating unit derived from terephthalic acid), a repeating unit in which Ar² is a 1,3-phenylene group (repeating unit derived from isophthalic acid), a repeating unit in which Ar² is a 2,6-naphthylene group (repeating unit derived from 2,6-naphthalenedicarboxylic acid), or a repeating unit in which Ar² is a diphenyl ether-4,4′-diyl group (repeating unit derived from diphenyl ether-4,4′-dicarboxylic acid) is preferable.

The repeating unit (3) is a repeating unit derived from predetermined aromatic diol, aromatic hydroxyamine or aromatic diamine.

As the repeating unit (3), a repeating unit in which Ar³ is a 1,4-phenylene group (repeating unit derived from hydroquinone, p-aminophenol or p-phenylenediamine), or a repeating unit in which Ar³ is a 4,4′-biphenylylene group (repeating unit derived from 4,4′-dihydroxybiphenyl, 4-amino-4′-hydroxybiphenyl, or 4,4′-diaminobiphenyl) is preferable.

The amount of the repeating unit (1) in the liquid crystal polyester is preferably equal to or greater than 30 mol %, more preferably 30 to 80 mol %, even more preferably 40 to 70 mol %, and particularly preferably 45 to 65 mol % with respect to a total amount of all of the repeating units constituting the liquid crystal polyester (value obtained by adding up the substance amount equivalent (mol) of each repeating unit, which is obtained by dividing mass of each repeating unit configuring the liquid crystal polyester by formula weight of each repeating unit).

In the liquid crystal polyester, as the amount of the repeating unit (1) is great, melt fluidity, heat resistance, and strength and rigidity are easily improved. In a case where the amount thereof is excessively great, for example, in a case where the amount thereof exceeds 80 mol %, a temperature necessary for molding easily increases.

The amount of the repeating unit (2) in the liquid crystal polyester is preferably equal to or smaller than 35 mol %, more preferably 10 to 35 mol %, even more preferably 15 to 30 mol %, and particularly preferably 17.5 to 27.5 mol % with respect to the total amount of all of the repeating units constituting the liquid crystal polyester.

The amount of the repeating unit (3) in the liquid crystal polyester is preferably equal to or smaller than 35 mol %, more preferably 10 to 35 mol %, even more preferably 15 to 30 mol %, and particularly preferably 17.5 to 27.5 mol % with respect to the total amount of all of the repeating units constituting the liquid crystal polyester.

In the liquid crystal polyester, the ratio of the amount of the repeating unit (2) and the amount of the repeating unit (3) is shown as [amount of the repeating unit (2)]/[amount of the repeating unit (3)] (mol/mol), and is preferably 0.9/1 to 1/0.9, more preferably 0.95/1 to 1/0.95, and even more preferably 0.98/1 to 1/0.98.

The liquid crystal polyesters may include one kind or two or more kinds of the repeating units (1) to (3) each independently. The liquid crystal polyester may include one kind or two or more kinds of a repeating unit other than the repeating units (1), (2), and (3), and the amount thereof is preferably 0 to 10 mol % and more preferably 0 to 5 mol % with respect to the total amount of all of the repeating units.

The liquid crystal polyester preferably includes a repeating unit in which X and Y each represent an oxygen atom as the repeating unit (3). To include a repeating unit in which X and Y each include an oxygen atom as the repeating unit (3) is to include a repeating unit derived from predetermined aromatic diol. This configuration is preferable because melt viscosity of the liquid crystal polyester easily decreases. It is more preferable that only a repeating unit in which X and Y each represent an oxygen atom is included as the repeating unit (3).

The liquid crystal polyester is preferably manufactured by causing melt polymerization of a raw material monomer corresponding to the repeating unit configuring the liquid crystal polyester, and causing solid-state polymerization of the obtained polymer (hereinafter, may be referred to as a “prepolymer”). Accordingly, it is possible to manufacture high-molecular weight liquid crystal polyester having high heat resistance, strength, and rigidity with excellent operability. The melt polymerization may be performed under the presence of a catalyst, and examples of the catalyst include a metal compound such as magnesium acetate, stannous acetate, tetrabutyl titanate, lead acetate, sodium acetate, potassium acetate, or antimony trioxide, and a nitrogen-containing heterocyclic compound such as 4-(dimethylamino) pyridine or 1-methylimidazole. As the catalyst, the nitrogen-containing heterocyclic compound is preferable.

The flow start temperature of the liquid crystal polyester defined below is preferably equal to or higher than 270° C., more preferably 270° C. to 400° C., and even more preferably 280° C. to 400° C. As the flow start temperature is high, heat resistance or strength and rigidity of the liquid crystal polyester are easily improved, and thus, the flow start temperature is preferably equal to or higher than 270° C. In a case where the flow start temperature is excessively high, for example, in a case where the flow start temperature exceeds 400° C., thermal deterioration easily occurs at the time of molding due to necessity of a high temperature for the melting, or fluidity is deteriorated due to an increase in viscosity at the time of melting.

The flow start temperature is also referred to as a flow temperature, is a temperature indicating a viscosity of 4,800 Pa·s (48,000 poise), in a case where liquid crystal polyester is melted while increasing a temperature at a rate of 4° C./min under a load of 9.8 MPa (100 kg/cm²) by using a capillary rheometer and extracted from a nozzle having an inner diameter of 1 mm and a length of 10 mm, and is a measure of molecular weight of the liquid crystal polyester (see “Liquid Crystal Polymers—Synthesis and Molding and Applications—”, edited by Naoyuki Koide, CMC Publishing Co., Ltd., Jun. 5, 1987, p. 95).

The liquid crystal polyester included in the liquid crystal polyester composition may be one kind or two or more kinds.

In a case where the liquid crystal polyester composition includes two or more kinds of liquid crystal polyesters, it is preferable to include at least liquid crystal polyester (A) and liquid crystal polyester (B) having different flow start temperatures.

The flow start temperature of the liquid crystal polyester (A) is preferably 310° C. to 400° C., more preferably 320° C. to 400° C., and even more preferably 330° C. to 400° C. By setting the flow start temperature to be equal to or higher than the lower limit, heat resistance of the liquid crystal polyester (A) further increases.

The flow start temperature of the liquid crystal polyester (B) is preferably 270° C. to 370° C., more preferably 280° C. to 370° C., and even more preferably 300° C. to 370° C. By setting the flow start temperature to be equal to or higher than the lower limit, the heat resistance of the liquid crystal polyester (B) further increases.

The difference between the flow start temperature of the liquid crystal polyester (A) and the flow start temperature of the liquid crystal polyester (B) is preferably 10° C. to 60° C., more preferably 20° C. to 60° C., and even more preferably 25° C. to 60° C. By setting the difference between the flow start temperatures to be in such a range, thin-wall fluidity of the liquid crystal polyester composition further increases, and molding workability is also further improved.

The amount of the liquid crystal polyester (B) in the liquid crystal polyester composition is preferably 10 to 200 parts by mass, more preferably 10 to 150 parts by mass, and even more preferably 10 to 120 parts by mass with respect to 100 parts by mass of the amount of the liquid crystal polyester (A). By setting the amount of the liquid crystal polyester (B) to be in such a range, thin-wall fluidity of the liquid crystal polyester composition further increases, and molding workability is also further improved.

In a case where the liquid crystal polyester composition includes any one or both of the liquid crystal polyester (A) and the liquid crystal polyester (B), the liquid crystal polyester composition may include or may not include liquid crystal polyester other than those. It is more preferable that the liquid crystal polyester other than the liquid crystal polyester (A) and the liquid crystal polyester (B) is not included.

For example, in a case where the liquid crystal polyester composition includes any one or both of the liquid crystal polyester (A) and the liquid crystal polyester (B), both the liquid crystal polyester (A) and the liquid crystal polyester (B) may be one kind or two or more kinds. The liquid crystal polyester other than the liquid crystal polyester (A) and the liquid crystal polyester (B), included in the liquid crystal polyester composition may also be one kind or two or more kinds.

[Plate-Like Inorganic Filler]

In a case where 10 g of the plate-like inorganic filler is mixed with 90 mL of ion exchange water having pH of 7.0 to prepare an aqueous dispersion, the pH of a solution portion of the aqueous dispersion (also referred to as an ion exchange water dispersion having a concentration of 10 mass % of the plate-like inorganic filler) (hereinafter, may be simply referred to as an “pH of aqueous dispersion”) is 7.0 to 9.0. Since the plate-like inorganic filler has a composition in which the pH of the aqueous dispersion is in such a range, hydrolysis of liquid crystal polyester is prevented, and blister resistance of a molded body obtained by molding the liquid crystal polyester composition increases.

The hydrolysis of the liquid crystal polyester easily occurs, for example, in a case of preparing the liquid crystal polyester composition pelletized by extrusion which will be described later, a case of manufacturing a molded body by molding the liquid crystal polyester composition, and the like, but in the embodiment the hydrolysis in these cases is prevented.

In this specification, unless otherwise noted, the description of a simple “aqueous dispersion” means an aqueous dispersion having pH of a solution portion of 7.0 to 9.0 described here.

From a viewpoint of further increasing the effect, the pH of the aqueous dispersion of the plate-like inorganic filler is preferably 7.3 to 9.0, more preferably 7.6 to 9.0, even more preferably 7.7 to 9.0, and particularly preferably 7.8 to 9.0.

The pH of the aqueous dispersion of the plate-like inorganic filler is preferably a value measured in a case where a temperature of the aqueous dispersion is 18° C. to 25° C.

As the aqueous dispersion, an aqueous dispersion which is in a state where the plate-like inorganic filler is evenly dispersed, or an aqueous dispersion which had been in a state where the plate-like inorganic filler was evenly dispersed, after mixing the total amount of the plate-like inorganic filler with the total amount of the ion exchange water, is preferable.

A mixing method of the plate-like inorganic filler and the ion exchange water is not particularly limited, as long as these components are sufficiently mixed, and for example, the mixing method may be suitably selected from well-known methods such as a method of performing the mixing by rotating a stirring bar or a stirring blade, a method of performing the mixing by adding ultrasonic waves, and the like.

Examples of the solution portion of the aqueous dispersion include a supernatant obtained by allowing the aqueous dispersion to stand, and a filtrate obtained by filtering the aqueous dispersion.

In the embodiment, as the plate-like inorganic filler, for example, an plate-like inorganic filler satisfying the pH condition described above may be used as it is, a plate-like inorganic filler caused to satisfy the pH condition described above by performing a pH adjustment treatment with respect to the plate-like inorganic filler not satisfying the pH condition described above may be used, or a plate-like inorganic filler obtained by performing a pH adjustment treatment with respect to the plate-like inorganic filler satisfying the pH condition described above so as to cause the plate-like inorganic filler to satisfy the pH condition described above may be used.

As an example of the pH adjustment treatment performed with respect to the plate-like inorganic filler described above, a treatment of washing the plate-like inorganic filler with a solution having pH of 7.0 to 9.0, a treatment of preparing an aqueous dispersion of the plate-like inorganic filler (hereinafter, this aqueous dispersion may be referred to as an “aqueous dispersion for pH adjustment”, in order to distinguish this aqueous dispersion from the aqueous dispersion described above regulating the pH), adding an acid or a base to the aqueous dispersion for pH adjustment to set pH thereof as 7.0 to 9.0, and extracting the plate-like inorganic filler, and the like are used.

In addition to satisfying the pH condition described above, the plate-like inorganic filler further has the particle diameter D90 of 20 to 140 μm. By setting the particle diameter D90 of the plate-like inorganic filler to be in such a range, hydrolysis of the liquid crystal polyester is prevented, and blister resistance of a molded body obtained by molding the liquid crystal polyester composition increases. In a case where the particle diameter D90 of the plate-like inorganic filler is equal to or greater than the lower limit value, a specific surface area of the plate-like inorganic filler decreases, and thus, the hydrolysis of the liquid crystal polyester is prevented.

In this specification, the “particle diameter D90” is a particle diameter corresponding to a cumulative percentage of 90% in cumulative particle diameter distribution of the plate-like inorganic filler based on volume, which is measured by using a laser diffraction/scattering type particle size distribution measuring device.

From a viewpoint of further increasing the effect, the particle diameter D90 of the plate-like inorganic filler is preferably 30 to 80 μm and more preferably 34 to 77 μm.

The particle diameter D90 of the plate-like inorganic filler can be adjusted by a method of adjusting the particle diameter of the plate-like inorganic filler, in a case of pulverizing a filler raw stone, or a method of adjusting the particle diameter of the plate-like inorganic filler by pulverizing a filler raw stone and classifying them.

The plate-like inorganic filler is not particularly limited as long as the conditions described above are satisfied, and examples thereof include mica, graphite, wollastonite, glass flake, barium sulfate, and calcium carbonate. Mica may be muscovite, phlogopite, fluorophlogopite, or tetrasilicic mica.

The plate-like inorganic filler may be used alone or in combination of two or more kinds thereof.

Among the examples described above, the plate-like inorganic filler is preferably mica.

The amount of the plate-like inorganic filler in the liquid crystal polyester composition is preferably 10 to 250 parts by mass, more preferably 20 to 200 parts by mass, even more preferably 20 to 150 parts by mass, and particularly preferably 30 to 100 parts by mass with respect to 100 parts by mass of the amount of the liquid crystal polyester. By setting the amount of the plate-like inorganic filler to be in such a range, blister resistance of a molded body obtained by molding the liquid crystal polyester composition further increases.

In addition, the amount of the plate-like inorganic filler is preferably 3 to 250 parts by mass with respect to 100 parts by mass of the other composition of the liquid crystal polyester composition.

(Other Components)

The liquid crystal polyester composition may include components other than the liquid crystal polyester and the plate-like inorganic filler.

Examples of the other components include inorganic fillers other than the plate-like inorganic filler and additives.

The other components may be included alone or in combination of two or more kinds thereof.

Examples of the inorganic fillers other than the plate-like inorganic filler include a fibrous inorganic filler and a particulate inorganic filler.

Examples of the fibrous inorganic filler include a glass fiber; a carbon fiber such as a pan-based carbon fiber or a pitch-based carbon fiber; a ceramic fiber such as a silica fiber, an alumina fiber, or a silica alumina fiber; and a metal fiber such as a stainless steel fiber. Examples of the fibrous inorganic filler include whiskers such as potassium titanate whiskers, barium titanate whiskers, wollastonite whiskers, aluminum borate whiskers, silicon nitride whiskers, and silicon carbide whiskers.

Examples of the particulate inorganic filler include silica, alumina, titanium oxide, glass beads, a glass balloon, boron nitride, silicon carbide, and calcium carbonate.

In the liquid crystal polyester composition, the amount of the inorganic fillers other than the plate-like inorganic filler is preferably 0 to 150 parts by mass with respect to 100 parts by mass of the amount of the liquid crystal polyester.

Examples of the additives include an antioxidant, a thermal stabilizer, an ultraviolet absorber, an antistatic agent, a surfactant, a flame retardant, and a colorant.

The amount of the additives in the liquid crystal polyester composition is preferably 0 to 5 parts by mass with respect to 100 parts by mass of the amount of the liquid crystal polyester.

The liquid crystal polyester composition is obtained, for example, by mixing the liquid crystal polyester, the plate-like inorganic filler, and the other components, if necessary; collectively or in appropriate order. A mixing method at this time is not particularly limited, and a mixing method using a well-known stirring device such as a tumbler mixer or a Henschel mixer is used.

A pelletized material obtained by melting and kneading of the obtained mixture by using an extruder or the like and extracting the kneaded material in a strand shape may be set as the liquid crystal polyester composition.

An extruder including a cylinder, one or more screws disposed in the cylinder, and one or more supply ports provided in the cylinder is preferable, and an extruder including one or more bend portion in the cylinder is more preferable.

The temperature at the time of melting and kneading is not particularly limited and is preferably 200° C. to 400° C. and more preferably 250° C. to 370° C.

<Molded Body>

The molded body of the embodiment is obtained by molding the liquid crystal polyester composition.

A manufacturing method of the molded body includes molding of the liquid crystal polyester composition. As a method of molding the liquid crystal polyester composition, a melt molding method is preferable, and examples of the melt molding method include an injection molding method; an extrusion molding method such as a T-die method or an inflation method; a compression molding method; a blow molding method; a vacuum molding method; and a press molding method. Among these, the molding method of the composition is preferably the injection molding method.

The molding conditions of the liquid crystal polyester composition are not particularly limited and suitably selected in accordance with the molding method. For example, in a case of performing the molding by the injection molding method, the molding may be performed by setting the cylinder temperature of an injection molding machine to preferably 250° C. to 400° C. and the die temperature to preferably 20° C. to 180° C.

The molded body of the embodiment has high blister resistance, by using the liquid crystal polyester composition. The blister resistance of the molded body, that is, the ease of generation of blisters on the molded body under high temperature conditions can be, for example, confirmed with a high value of soldering heat resistance of the molded body.

For example, in a case where JIS K7113 (½) type dumbbell test pieces (thickness of 1.2 mm) which will be described later in examples are prepared as the molded body of the embodiment, 10 test pieces are dipped in a solder bath heated to 270° C. for 60 seconds and extracted, surfaces of these 10 test pieces are visually observed, and the number of test pieces having surfaces, where blisters are observed, is counted, the number is preferably equal to or smaller than 4 and more preferably equal to or smaller than 3.

The molded body of the embodiment has high heat resistance by selecting the type of liquid crystal polyester, for example. For example, in a case a rod-like test piece having a width 6.4 mm, a length of 127 mm, and a thickness of 12.7 mm as will be described later in examples is prepared as the molded body of the embodiment, a deflection temperature under load of the test piece in a case where the measurement is performed under the conditions of a load of 1.82 MPa and a rate of a temperature increase of 2° C./min based on ASTM D648 is preferably equal to or higher than 230° C., more preferably equal to or higher than 234° C., and can also be, for example, equal to or greater than 270° C. or equal to or higher than 280° C.

Examples of a product, equipment, a component or a member configured with the molded body of the embodiment include a bobbin such as an optical pickup bobbin or a transformer bobbin; a relay component such as a relay case, a relay base, a relay sprue, or a relay armature; a connector such as a RIMM, a DDR, a CPU socket, a S/O, a DIMM, a Board-to-Board connector, an FPC connector, or a card connector; a reflector such as a lamp reflector or an LED reflector; a holder such as a lamp holder or a heater holder; a diaphragm such as a speaker diaphragm; a separation claw such as a separation claw for a copier or a separation claw for a printer; a camera module component; a switch component; a motor component; a sensor component; a hard disk drive component; tableware such as ovenware; a car component; a battery component; an aircraft part; and a sealing member such as a sealing member for a semiconductor element or a sealing member for a coil.

Among these, the molded body of the embodiment is preferably a connector and is more preferably a connector obtained by performing the molding by the injection molding method. Here, the connector mainly indicates equipment used for connection between members such as electronic equipment, or a member used at the connected portion of the equipment, and particularly indicates the member used for connection between wires such as cords of electronic equipment.

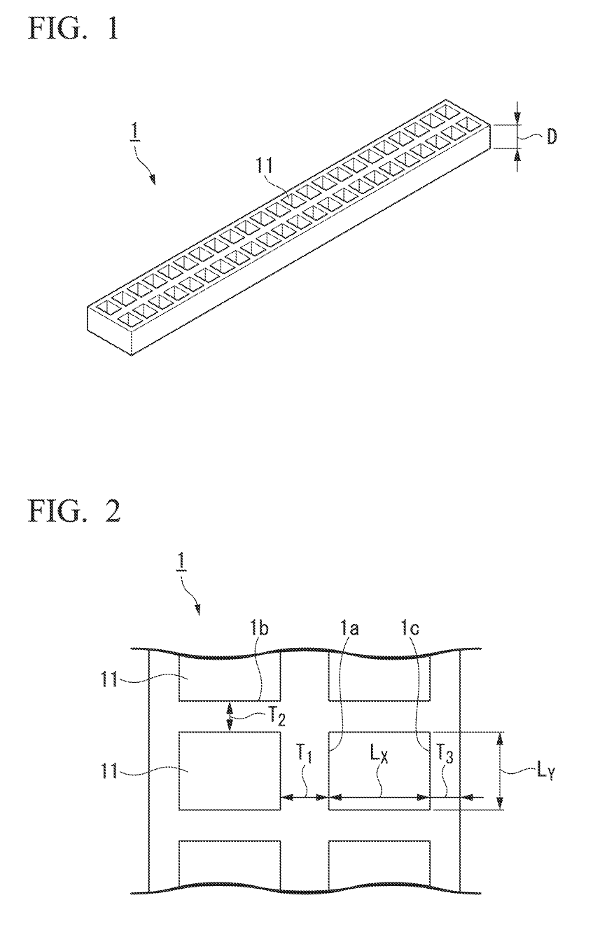

FIG. 1 is a perspective view schematically showing a connector of an aspect of the embodiment and FIG. 2 is an enlarged front view showing main parts of the connector shown in FIG. 1.

A connector 1 shown here has a rectangular shape, and a plurality of terminal insertion ports 11 having square (rectangular) openings are disposed to be arranged in two rows.

A thickness D of the connector 1 is preferably 3 to 50 mm and more preferably 4 to 10 mm.

In the opening of the terminal insertion port 11, a length of a long side is L_{X} and a length of a short side is L_{Y}.

In a short direction of the connector 1, that is, a long side direction of the opening of the terminal insertion port 11, a portion which separates the adjacent terminal insertion ports 11 from each other is a thin wall portion (hereinafter, referred to as a “first thin wall portion”) 1a and a thickness thereof is T₁. In addition, in a longitudinal direction of the connector 1, that is, a short side direction of the opening of the terminal insertion port 11, a portion which separates the adjacent terminal insertion ports 11 from each other is a thin wall portion (hereinafter, referred to as a “second thin wall portion”) 1b and the thickness thereof is T₂. Further, a side wall 1c of the connector 1 which forms a part of the terminal insertion port 11 is also a thin wall portion and the thickness thereof is T₃.

In the connector 1, L_{X} is preferably 0.5 to 3 mm and more preferably 1 to 2 mm. In addition, L_{Y} is preferably 0.3 to 3 mm and more preferably 0.5 to 2 mm.

In the connector 1, T₁ is preferably 0.3 to 3 mm and more preferably 0.5 to 2 mm. In addition, T₂ is preferably 0.1 to 3 mm and more preferably 0.3 to 2 mm. Further, T₃ is preferably 0.1 to 3 mm and more preferably 0.3 to 2 mm.

The connector 1 having such thin wall portions has a particularly excellent effect that a blister is hardly generated under high temperature conditions, as the molded body.

The connector 1 shown in FIG. 1 is merely an aspect of the embodiment, and the connector of the embodiment is not limited thereto. For example, the terminal insertion ports 11 may not be arranged in two rows, and the shape of the connector may be a shape other than a rectangular shape such as plate shape in accordance with the disposition state of the terminal insertion ports 11.

### EXAMPLES

Hereinafter, the invention will be described more specifically with reference to examples. However, the embodiment of the invention is not limited to the examples shown below.

Plate-like inorganic fillers used in the following examples and comparative examples are shown below.

### (Plate-Like Inorganic Filler)

Plate-like inorganic filler (F1): mica (“CS-25” manufactured by Seishin Enterprise Co., Ltd.)

Plate-like inorganic filler (F2): mica (“YM-25S” manufactured by Yamaguchi Mica Co., Ltd.)

Plate-like inorganic filler (F3): mica (“MMC-325” manufactured by Mica Manufacturing Co. Pvt. Ltd.)

Plate-like inorganic filler (F4): mica (“CS-5” manufactured by Seishin Enterprise Co., Ltd.)

Plate-like inorganic filler (F5): mica (“CS-35” manufactured by Seishin Enterprise Co., Ltd.)

Plate-like inorganic filler (F6): mica (“M-400” manufactured by Repco Co., Ltd.)

Plate-like inorganic filler (F7): mica (“A-21S” manufactured by Yamaguchi Mica Co., Ltd.)

Plate-like inorganic filler (F8): mica (“600W” manufactured by Kirara Corporation)

Plate-like inorganic filler (F9): mica (“400W” manufactured by Kirara Corporation)

Plate-like inorganic filler (F10): mica (“W300” manufactured by LING SHOD HUAJING M ICA Co., Ltd.)

The pH of the aqueous dispersion and the particle diameter D90 of the plate-like inorganic fillers (F1) to (F10) were measured by the following methods.

<Measurement of pH of Aqueous Dispersion of Plate-Like Inorganic Filler>

10 g of the plate-like inorganic filler was added into 90 mL of ion exchange water having a pH of 7.0 and stirred at 24° C. for 1 minute to obtain an aqueous dispersion, in which undissolved materials were evenly dispersed, the aqueous dispersion was left to stand at the same temperature for 5 minutes, and the pH of supernatant (solution portion) was measured with a pH meter.

<Measurement of Particle Diameter D90 of Plate-Like Inorganic Filler>

A particle diameter corresponding to a cumulative percentage of 90% in cumulative particle diameter distribution of the plate-like inorganic filler based on volume was obtained, which was measured by using a laser diffraction/scattering type particle size distribution measuring device (“LA-950V2” manufactured by HORIBA, Ltd.).

### Preparation of Liquid Crystal Polyester

### Preparation Example 1

994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. for 30 minutes while stirring under a nitrogen gas flow, and reflux was performed at 150° C. for 30 minutes.

Then, 2.4 g of 1-methylimidazole was added thereto, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 250° C. for 1 hour under a nitrogen atmosphere, further heated from 250° C. to 295° C. for 5 hours, and held at 295° C. for 3 hours, thereby performing solid phase polymerization. The obtained solid-phase polymer was cooled to room temperature and powder-like liquid crystal polyester (L1) was obtained. The flow start temperature of the liquid crystal polyester (L1) was 327° C.

### Preparation Example 2

994.5 g (7.2 mol) of p-hydroxybenzoic acid, 239.2 g (1.44 mol) of terephthalic acid, 159.5 g (0.96 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. for 30 minutes while stirring under a nitrogen gas flow, and reflux was performed at 150° C. for 30 minutes.

Then, 2.4 g of 1-methylimidazole was added thereto, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 220° C. for 1 hour under a nitrogen atmosphere, further heated from 220° C. to 240° C. for 30 minutes, and held at 240° C. for 10 hours, thereby performing solid phase polymerization. The obtained solid-phase polymer was cooled to room temperature and powder-like liquid crystal polyester (L2) was obtained. The flow start temperature of the liquid crystal polyester (L2) was 286° C.

### Preparation Example 3

994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. for 30 minutes while stirring under a nitrogen gas flow, and reflux was performed at 150° C. for 30 minutes.

Then, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 250° C. for 1 hour under a nitrogen atmosphere, further heated from 250° C. to 295° C. for 5 hours, and held at 295° C. for 3 hours, thereby performing solid phase polymerization. The obtained solid-phase polymer was cooled to room temperature and powder-like liquid crystal polyester (L3) was obtained. The flow start temperature of the liquid crystal polyester (L3) was 327° C.

### Preparation Example 4

994.5 g (7.2 mol) of p-hydroxybenzoic acid, 358.8 g (2.16 mol) of terephthalic acid, 39.9 g (0.24 mol) of isophthalic acid, 446.9 g (2.4 mol) of 4,4′-dihydroxybiphenyl, and 1347.6 g (13.2 mol) of acetic anhydride were put into a reaction vessel including a stirring device, a torque meter, a nitrogen gas introduction pipe, a thermometer, and a reflux condenser, gas in the reaction vessel was substituted with nitrogen gas, 0.18 g of 1-methylimidazole was added thereto, the temperature was increased from room temperature to 150° C. for 30 minutes while stirring under a nitrogen gas flow, and reflux was performed at 150° C. for 30 minutes.

Then, the temperature was increased from 150° C. to 320° C. for 2 hours and 50 minutes while distilling byproduct acetic acid and unreacted acetic anhydride, the content was extracted from the reaction vessel and cooled to room temperature, at the time point when an increase in torque was recognized, and a prepolymer which is a solid matter was obtained.

Then, this prepolymer was pulverized by a pulverizer, the obtained pulverized material was heated from room temperature to 250° C. for 1 hour under a nitrogen atmosphere, further heated from 250° C. to 295° C. for 5 hours, and held at 295° C. for 3 hours, thereby performing solid phase polymerization. The obtained solid-phase polymer was cooled to room temperature and powder-like liquid crystal polyester (L4) was obtained. The flow start temperature of the liquid crystal polyester (L4) was 360° C.

### Preparation of Liquid Crystal Polyester Composition

### Examples 1, 2 and 5 and Comparative Examples 1 to 5

The type of liquid crystal polyester and the type of plate-like inorganic filler shown in Tables 1 and 2 were mixed at the ratio shown in Tables 1 and 2 by using a Henschel mixer, the mixture obtained by setting a cylinder temperature as 330° C. was granulated by using a twin-screw extruder (“PCM-30 Type” manufactured by Ikegai Corporation), thereby obtaining a pelleted liquid crystal polyester composition.

### Examples 3 and 4 and Comparative Examples 6 and 7

The type of liquid crystal polyester and the type of plate-like inorganic filler shown in Tables 1 and 2 were mixed at the ratio shown in Tables 1 and 2 by using a Henschel mixer, the mixture obtained by setting a cylinder temperature as 360° C. was granulated by using a twin-screw extruder (“PCM-30 Type” manufactured by Ikegai Corporation), thereby obtaining a pelleted liquid crystal polyester composition.

<Preparation and Evaluation of Molded Body>

A molded body was manufactured from the liquid crystal polyester composition obtained in each of the examples and the comparative examples by the following method, and soldering heat resistance and heat resistance were evaluated. The results are shown in Tables 1 and 2.

(Evaluation of Soldering Heat Resistance of Molded Body)

A JIS K7113 (½) type dumbbell test pieces (thickness of 1.2 mm) were manufactured from the liquid crystal polyester composition as the molded body, by using an injection molding machine (“PS40E5ASE” manufactured by Nissei Plastic Industrial Co., Ltd.) under the conditions of a cylinder temperature of 350° C., a die temperature of 130° C., and an injection rate of 75 mm/sec.

Then, the 10 dumbbell test pieces obtained were dipped in a solder bath heated to 270° C. for 60 seconds and extracted, surfaces of these 10 test pieces were visually observed, and the number of test pieces having surfaces, where blisters were observed, was counted, to evaluate the soldering heat resistance of the test pieces from the number.

(Evaluation of Heat Resistance of Molded Body)

A rod-like test piece having a width of 6.4 mm, a length of 127 mm, and a thickness of 12.7 mm was manufactured from the liquid crystal polyester composition as the molded body, by using an injection molding machine (“PS40E5ASE” manufactured by Nissei Plastic Industrial Co., Ltd.) under the conditions of a cylinder temperature of 350° C., a die temperature of 130° C., and an injection rate of 60 mm/sec.

Then, regarding the obtained rod-like test piece, a deflection temperature under load was measured with a load of 1.82 MPa at a rate of a temperature increase of 2° C./min based on ASTM D648, and heat resistance was evaluated.

TABLE 1

| | | Example 1 | Example 2 | Example 3 | Example 4 | Example 5 |
|---|---|---|---|---|---|---|
| Component | Liquid crystal polyester | (L1)55 | (L1)55 | (L3)50 | (L3)50 | (L1)55 |
| | Parts by mass | (L2)45 | (L2)45 | (L4)50 | (L4)50 | (L2)45 |
| | Plate-like inorganic filler | (F1)33 | (F2)33 | (F1)43 | (F2)43 | (F10)33 |
| | Parts by mass | | | | | |
| Plate-like | Aqueous dispersion pH | 8.7 | 8.0 | 8.7 | 8.0 | 7.7 |
| inorganic | Particle diameter D90 | 74.0 | 38.2 | 74.0 | 38.2 | 62.5 |
| filler | | | | | | |
| Evaluation | Soldering heat resistance | 1 | 2 | 2 | 1 | 3 |
| result of | (number) | | | | | |
| molded body | Heat resistance (° C.) | 231 | 249 | 283 | 290 | 238 |

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Component | Liquid crystal | (L1)55 | (L1)55 | (L1)55 | (L1)55 | (L1)55 | (L3)50 | (L3)50 |
| | polyester Parts | (L2)45 | (L2)45 | (L2)45 | (L2)45 | (L2)45 | (L4)50 | (L4)50 |
| | by mass | | | | | | | |
| | Plate-like | (F3)33 | (F4)33 | (F5)33 | (F6)33 | (F7)33 | (F8)43 | (F9)43 |
| | inorganic | | | | | | | |
| | filler Parts | | | | | | | |
| | by mass | | | | | | | |
| Plate-like | Aqueous | 8.8 | 8.7 | 8.5 | 9.4 | 9.1 | 5.9 | 6.4 |
| inorganic | dispersion pH | | | | | | | |
| filler | Particle | 17.8 | 10.0 | 144.3 | 42.0 | 35.2 | 13.6 | 53.4 |
| | diameter D90 | | | | | | | |
| Evaluation | Soldering heat | 9 | 10 | 9 | 8 | 9 | 10 | 10 |
| result of | resistance | | | | | | | |
| molded body | (number) | | | | | | | |
| | Heat resistance | 225 | 224 | 235 | 230 | 242 | 257 | 276 |
| | (° C.) | | | | | | | |

As shown from the results, in Examples 1 to 5, by using the plate-like inorganic filler (F1), (F2), or (F10) as the plate-like inorganic filler in the liquid crystal polyester composition, the soldering heat resistance of the obtained molded bodies was high and generation of a blister under high temperature conditions was prevented. In addition, the molded bodies had high heat resistance and particularly preferable properties as the molded body.

Both of the liquid crystal polyesters (L1) and (L2) and the liquid crystal polyesters (L3) and (L4) are in a relationship of the liquid crystal polyesters (A) and (B) described above, but the liquid crystal polyesters (L3) and (L4) are a more preferable combination than the liquid crystal polyesters (L1) and (L2), and thus, excellent heat resistance of the molded bodies was obtained in Examples 3 and 4, compared to that in Examples 1 and 2.

On the other hand, in Comparative Examples 1 to 7, the soldering heat resistance of the obtained molded bodies was low. A more specific description is as follows.

In Comparative Examples 1 to 3, regardless of the usage of the same liquid crystal polyester as that in Examples 1 and 2 in the liquid crystal polyester composition, the soldering heat resistance of the obtained molded bodies was deteriorated, compared to that in Examples 1 and 2, by using the plate-like inorganic filler (F3), (F4), or (F5) as the plate-like inorganic filler. In addition, in Comparative Examples 1 and 2, heat resistance of the molded body was also deteriorated, compared to that in Examples 1 and 2. It is assumed that the particle diameters D90 of the plate-like inorganic fillers (F3) and (F4) were excessively small, and the particle diameter D90 of the plate-like inorganic filler (F5) was excessively great.

In Comparative Examples 4 and 5, regardless of the usage of the same liquid crystal polyester as that in Examples 1 and 2 in the liquid crystal polyester composition, the soldering heat resistance of the obtained molded body was deteriorated, compared to that in Examples 1 and 2, by using the plate-like inorganic filler (F6) or (F7) as the plate-like inorganic filler. It is assumed that the pH of the aqueous dispersion of the plate-like inorganic fillers (F6) and (F7) was excessively high.

In Comparative Example 7, regardless of the usage of the same liquid crystal polyester as that in Examples 3 and 4 in the liquid crystal polyester composition, the soldering heat resistance and the heat resistance of the molded body were deteriorated, compared to that in Examples 3 and 4, by using the plate-like inorganic filler (F9) as the plate-like inorganic filler. It is assumed that the pH of the aqueous dispersion of the plate-like inorganic filler (F9) was excessively low.

In Comparative Example 6, regardless of the usage of the same liquid crystal polyester as that in Examples 3 and 4 in the liquid crystal polyester composition, the soldering heat resistance and the heat resistance of the molded body were deteriorated, compared to that in Examples 3 and 4, by using the plate-like inorganic filler (F8) as the plate-like inorganic filler. It is assumed that the particle diameter D90 of the plate-like inorganic filler (F8) was excessively small and the pH of the aqueous dispersion thereof was excessively low.

However, in Comparative Examples 6 and 7, heat resistance of the molded body was more excellent than that in Comparative Examples 1 to 5, and this implies that it is due to the selection of a combination of the liquid crystal polyesters (L3) and (L4), rather than the liquid crystal polyesters (L1) and (L2).

### Manufacturing of Connector

### Example 5

The liquid crystal polyester composition obtained in Example 1 was dried at 120° C. for 12 hours, and injection molding was performed by using an injection molding machine (“PS40E5ASE” manufactured by Nissei Plastic Industrial Co., Ltd.) under the conditions of a cylinder temperature of 350° C. and a die temperature of 130° C., thereby manufacturing the connector shown in FIG. 1. In this connector, D is 6 mm, L_{X} is 1.1 mm, L_{Y} is 0.8 mm, T₁ is 0.8 mm, T₂ is 0.5 mm, and T₃ is 0.4 mm. The obtained connector has excellent soldering heat resistance, in the same manner as the molded bodies of Examples 1 to 5.

### INDUSTRIAL APPLICABILITY

The invention can be used for a molded body required to have high heat resistance, such as an electric and electronic component, particularly a connector.

### REFERENCE SIGNS LIST

1 connector
11 terminal insertion port
D thickness of connector
L_{X} length of long side of opening of terminal insertion port
L_{Y} length of short side of opening of terminal insertion port
1a first thin wall portion
1b second thin wall portion
1c side wall of connector
T₁ thickness of first thin wall portion
T₂ thickness of second thin wall portion
T₃ thickness of side wall of connector

1. A liquid crystal polyester composition comprising:
liquid crystal polyester; and
a plate-like inorganic filler,
wherein, in a case where 10 g of the plate-like inorganic filler is mixed with 90 mL of ion exchange water having pH of 7.0 to prepare an aqueous dispersion, pH of a solution portion of the aqueous dispersion is 7.0 to 9.0, and
a particle diameter D90 of the plate-like inorganic filler is 20 to 140 μm.

2. The liquid crystal polyester composition according to claim 1,
wherein an amount of the plate-like inorganic filler is 10 to 250 parts by mass with respect to 100 parts by mass of an amount of the liquid crystal polyester.

3. The liquid crystal polyester composition according to claim 1,
wherein the plate-like inorganic filler is mica.

4. The liquid crystal polyester composition according to claim 1,
wherein the particle diameter D90 of the plate-like inorganic filler is 30 to 80 μm.

5. The liquid crystal polyester composition according to claim 1,
wherein the liquid crystal polyester includes a repeating unit represented by General Formula (1), a repeating unit represented by General Formula (2), and a repeating unit represented by General Formula (3).
—O—Ar¹—CO— (1)
—CO—Ar²—CO— (2)
—X—Ar³—Y— (3)
[in Formulae (1) to (3), Ar¹ represents one selected from the group consisting of a phenylene group, a naphthylene group, and a biphenylylene group, Ar² and Ar³ each independently represent one selected from the group consisting of a phenylene group, a naphthylene group, a biphenylylene group, and a group represented by General Formula (4), X and Y each independently represent an oxygen atom or an imino group, one or more hydrogen atoms in the group represented by Ar¹, Ar², or Ar³ may each be independently substituted with one selected from the group consisting of a halogen atom, an alkyl group having 1 to 28 carbon atoms, and an aryl group having 6 to 12 carbon atoms]
—Ar⁴—Z—Ar⁵— (4)
[in Formula (4), Ar⁴ and Ar⁵ each independently represent a phenylene group or a naphthylene group, and Z represents one selected from the group consisting of an oxygen atom, a sulfur atom, a carbonyl group, a sulfonyl group, and an alkylidene group having 1 to 28 carbon atoms]

6. A molded body obtained by molding the liquid crystal polyester composition according to claim 1.

7. A connector obtained by molding the liquid crystal polyester composition according to claim 1.
